(19) United States
(12) Patent Application Publication
(10) Pub. No.: US 2024/0424952 A1
(43) Pub. Date: Dec. 26, 2024

(54) BATTERY CELL BALANCING TECHNIQUES FOR ELECTRIFIED VEHICLE BATTERY MANAGEMENT SYSTEMS

(71) Applicant: FCA US LLC, Auburn Hills, MI (US)

(72) Inventors: Ye Hua Pang, Changsha (CN); Zhong Zheng, Shanghai (CN); Zhenquan Chen, Shanghai (CN); Yang Xu, Shanghai (CN)

(21) Appl. No.: 18/340,946

(22) Filed: Jun. 26, 2023

(51) Int. Cl. B60L 58/22; B60L 58/12; H02J 7/00

(52) U.S. Cl. CPC B60L 58/22; B60L 58/12; H02J 7/0014; H02J 7/0048; B60L 2240/547

(57) ABSTRACT

Battery management techniques for performing cell balancing for a high voltage (HV) battery system of an electrified vehicle include detecting an ignition-off transition whereby the electrified vehicle is transitioned to a park state and subsequently powered off, during the ignition-off transition, obtaining a set of measured parameters including at least (i) voltages of a plurality of HV battery cells of the HV battery system and (ii) a state of charge (SOC) of a low voltage (LV) battery system of the electrified vehicle, and after the electrified vehicle is subsequently powered off, performing cell balancing of voltages of the plurality of HV battery cells of the HV battery system using the set of measured parameters, wherein the performing of cell balancing of the voltages of the plurality of HV battery cells extends a useful life of the HV battery system.

### FIELD

The present application generally relates to electrified vehicle battery systems and, more particularly, to battery cell balancing techniques for an electrified vehicle battery management system (BMS).

### BACKGROUND

Electrified vehicles typically include multiple battery systems, such as a high voltage (HV) battery system for powering one or more electric traction motors for vehicle propulsion, and a low voltage (LV) battery system (e.g., a 12 volt or 12V battery) for powering one or more accessory loads. One of the primary tasks of an electrified vehicle's battery management system (BMS) is to perform “cell balancing.” Cell balancing refers to the process of periodically balancing the voltages across the various cells of a battery system such that each of the cells has an approximately same voltage level. The primary purpose of performing cell balancing is to extend or maximize the useful life of a battery system, which is particularly important for the large and expensive HV battery system of an electrified vehicle.

In conventional electrified vehicles, the BMS performs cell balancing of the HV battery system only during certain operating conditions, which typically correspond to an extended period of relatively stable/non-dynamic operation (e.g., highway driving). Some drivers, however, do not drive their electrified vehicles that often and thus these operating conditions may be rarely or never encountered. This results in the BMS never being able to perform cell balancing of the HV battery system. The electrified vehicle therefore requires additional hardware to perform cell balancing, which increases costs/complexity. Accordingly, while such conventional electrified vehicle battery management systems do work for their intended purpose, there exists an opportunity for improvement in the relevant art.

### SUMMARY

According to one example aspect of the invention, a battery management system (BMS) for a high voltage (HV) battery system of an electrified vehicle is presented. In one exemplary implementation, the BMS comprises a set of sensors configured to determine a set of measured parameters including at least (i) voltages of a plurality of HV battery cells of the HV battery system and (ii) a state of charge (SOC) of a low voltage (LV) battery system of the electrified vehicle and a controller configured to detect an ignition-off transition whereby the electrified vehicle is transitioned to a park state and subsequently powered off, during the ignition-off transition, obtain the set of measured parameters from the set of sensors, and after the electrified vehicle is subsequently powered off, perform cell balancing of voltages of the plurality of HV battery cells of the HV battery system using the set of measured parameters, wherein the performing of cell balancing of the voltages of the plurality of HV battery cells extends a useful life of the HV battery system.

In some implementations, the controller is configured to perform cell balancing while the electrified vehicle is asleep and prior to the electrified vehicle being awoken and powered on. In some implementations, the controller is not configured to perform cell balancing during specific stable/non-dynamic operating conditions of the electrified vehicle. In some implementations, the BMS does not require additional hardware to perform cell balancing during operation of the electrified vehicle.

In some implementations, the controller is configured to perform cell balancing when the measured SOC of the LV battery system satisfies a minimum SOC threshold. In some implementations, the minimum SOC threshold corresponds to a required amount of SOC from the LV battery system for distribution amongst the plurality of HV battery cells as part of the cell balancing. In some implementations, the BMS does not actively monitor, using the set of sensors, the measured voltages of the plurality of HV battery cells of the HV battery system during operation of the electrified vehicle.

According to another example aspect of the invention, a battery management method for performing cell balancing for a HV battery system of an electrified vehicle is presented. In one exemplary implementation, the method comprises detecting, by a controller, an ignition-off transition whereby the electrified vehicle is transitioned to a park state and subsequently powered off, during the ignition-off transition, obtaining, by the controller and from a set of sensors, a set of measured parameters including at least (i) voltages of a plurality of HV battery cells of the HV battery system and (ii) a state of charge (SOC) of a low voltage (LV) battery system of the electrified vehicle and, after the electrified vehicle is subsequently powered off, performing, by the controller, cell balancing of voltages of the plurality of HV battery cells of the HV battery system using the set of measured parameters, wherein the performing of cell balancing of the voltages of the plurality of HV battery cells extends a useful life of the HV battery system.

In some implementations, the cell balancing is performed by the controller while the electrified vehicle is asleep and prior to the electrified vehicle being awoken and powered on. In some implementations, the controller is not configured to perform cell balancing during specific stable/non-dynamic operating conditions of the electrified vehicle. In some implementations, the electrified vehicle does not require additional hardware to perform cell balancing during operation of the electrified vehicle.

In some implementations, the cell balancing is performed by the controller when the measured SOC of the LV battery system satisfies a minimum SOC threshold. In some implementations, the minimum SOC threshold corresponds to a required amount of SOC from the LV battery system for distribution amongst the plurality of HV battery cells as part of the cell balancing. In some implementations, the controller does not actively monitor, using the set of sensors, the measured voltages of the plurality of HV battery cells of the HV battery system during operation of the electrified vehicle.

Further areas of applicability of the teachings of the present application will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present application are intended to be within the scope of the present application.

### BRIEF DESCRIPTION OF THE DRAWINGS

FIG. 1 is a functional block diagram of an electrified vehicle having a high voltage (HV) battery system and an example battery management system (BMS) according to the principles of the present application;

FIG. 2 is a functional block diagram of an example architecture for the BMS according to the principles of the present application; and

FIG. 3 is a flow diagram of an example battery management method for performing cell balancing for a HV battery system of an electrified vehicle according to the principles of the present application.

### DESCRIPTION

As previously discussed, a conventional electrified vehicle battery management system (BMS) performs cell balancing of a high voltage (HV) battery system only during certain operating conditions, which typically corresponds to an extended period of relatively stable/non-dynamic operation (e.g., highway driving). Some drivers, however, do not drive their electrified vehicles that often and thus these operating conditions may be rarely or never encountered. This results in the BMS never being able to perform cell balancing of the HV battery system. The electrified vehicle therefore requires additional hardware to perform cell balancing, which increases costs/complexity.

Accordingly, techniques are presented herein where the BMS is configured to initiate cell balancing during ignition-off (e.g., vehicle park) transitions where the electrified vehicle is powering down. During this period, parameters are gathered (HV battery cell voltage, low voltage (LV) battery system state of charge (SOC), etc.) and used to determine if cell balancing is necessary and, if so, whether it is possible. When possible, cell balancing is performed while the vehicle is asleep and unbeknownst to the driver. The benefits of these techniques include the ability to provide cell balancing even for rarely used or driven electrified vehicles, which in turn prolongs the life of their HV battery systems and potentially decreases replacement costs.

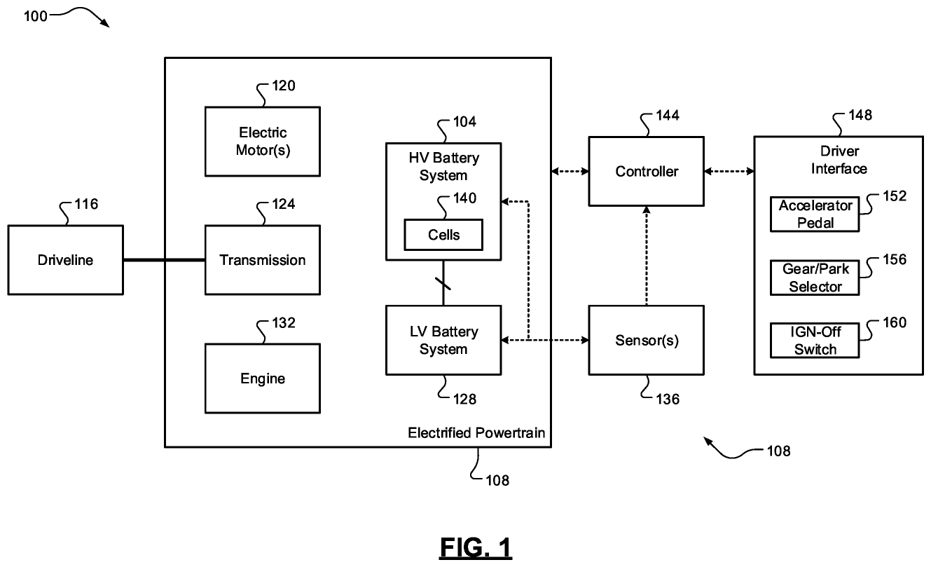

Referring now to FIG. 1, a functional block diagram of an electrified vehicle 100 having a HV battery system 104 and an example BMS 108 according to the principles of the present application is illustrated. It will be appreciated that the electrified vehicle 100 could be any suitable type of electrified vehicle having a BMS including, but not limited to, a battery electric vehicle (BEV), a plug-in hybrid electric vehicle (PHEV), and an extended range electrified vehicle (EREV). The electrified vehicle 100 comprises an electrified powertrain 112 configured to generate and transfer drive torque to a driveline 116 for vehicle propulsion. The electrified powertrain 112 includes one or more electric motors 120 configured to generate mechanical torque in response to power or current supplied by the HV battery system 104 (e.g., via an inverter, not shown). The drive torque is transferred to the driveline 116 via a transmission 124, such as an automatic transmission.

A LV battery system 128 (e.g., a 12 volt (V) battery system, such as a 12V lithium-ion (Li-ion) or lead-acid battery) is configured to power one or more accessory components of the electrified vehicle 100. A DC-DC converter (not shown) could be integrated between the HV and LV battery systems 104, 128. In some implementations, the electrified powertrain 108 also comprises an internal combustion engine 132 configured to combust a mixture of air and fuel (gasoline, diesel, etc.) to generate mechanical drive torque, which could be used for vehicle propulsion and/or for recharging the battery systems 104, 128.

The HV battery system 104, for example, could comprise a plurality of HV battery cells 140 (e.g., Li-ion battery cells each rated at ˜1-5V each) each connected in series such that the HV battery system 104 outputs a sum of the voltages of the HV battery cells 140. The BMS 108 is configured to manage at least the HV battery system 104, including monitoring, via a set of one or more sensors 136, a set of parameters of the HV and LV battery systems 104, 128 (state of charge (SOC), cell voltages, etc.). As previously discussed, cell balancing refers to the process of balancing the voltages across the HV battery cells 140. The electrified vehicle 100 also includes a controller 144 configured to control operation of the electrified powertrain 108 including, but not limited to, controlling the electrified powertrain 108 to satisfy a torque request provided by a driver or operator of the electrified vehicle 100 via an accelerator pedal 152 of a driver interface 148 (e.g., an accelerator pedal).

The driver interface 148 could also include other driver-controlled or actuated components including, but not limited to, a transmission gear selector or park selector 156 and an ignition-off or power-off switch 160. For purposes of the present disclosure, the BMS 108 could include either its own standalone controller (not shown) or the BMS 108 could utilized (e.g., be at least partially implemented by) the controller 144 of the electrified vehicle 100. The operation of the BMS 108, including the cell balancing techniques of the present application, will now be discussed in greater detail.

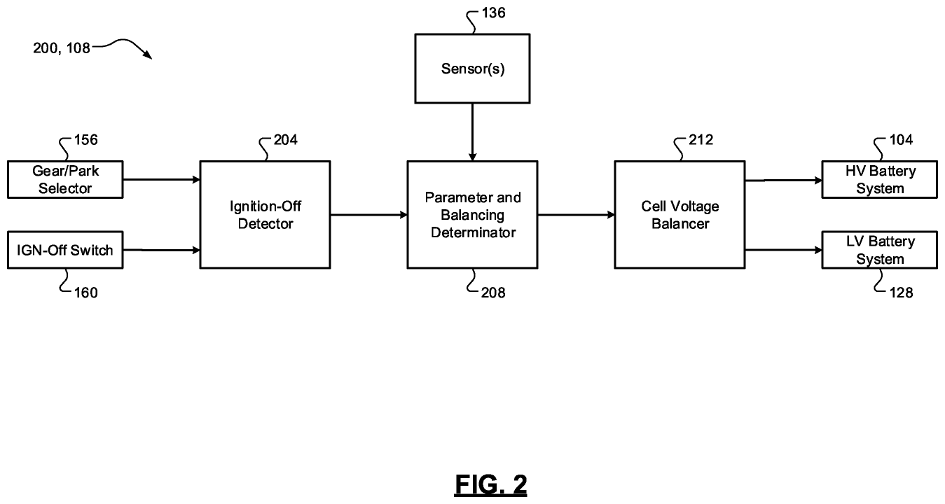

Referring now to FIG. 2, a functional block diagram of an example architecture 200 for the BMS 108 according to the principles of the present application is illustrated. The architecture 200 includes an ignition-off detector 204 configured to detect an ignition-off transition whereby the electrified vehicle 100 is transitioned to a park state and subsequently powered off. This could be determined, for example, by monitoring the gear/park selector 156 and the power-off switch 160 of the driver interface 148. During the ignition-off transition, a parameter and balance determinator 208 obtains the set of measured parameters from the set of sensors 136, including at least voltages of the plurality of HV battery cells 140 of the HV battery system 104 and (ii) the SOC of the LV battery system 128.

After the electrified vehicle 100 is subsequently powered off and cell balancing is necessary, a cell voltage balancer 212 performs cell balancing of the voltages of the plurality of HV battery cells 140 of the HV battery system 104 using the set of measured parameters. In other words, the cell voltage balancer 212 is configured to perform cell balancing while the electrified vehicle 100 is asleep and prior to the electrified vehicle 100 being awoken and powered on. More particularly, the cell voltage balancer 212 performs cell balancing when the measured SOC of the LV battery system 128 satisfies a minimum SOC threshold and when cell balancing is necessary (e.g., when any cell voltage(s) differ by more than a threshold amount from other cell voltages or an average cell voltage). For example, this minimum SOC threshold could correspond to a required amount of SOC from the LV battery system 128 for distribution amongst the plurality of HV battery cells 140 as part of the cell balancing process. The cell balancing process could be performed in any suitable manner, such as controlling pulse-width modulation (PWM) control signals (e.g., duty cycles) provided to each of the various battery cells 140.

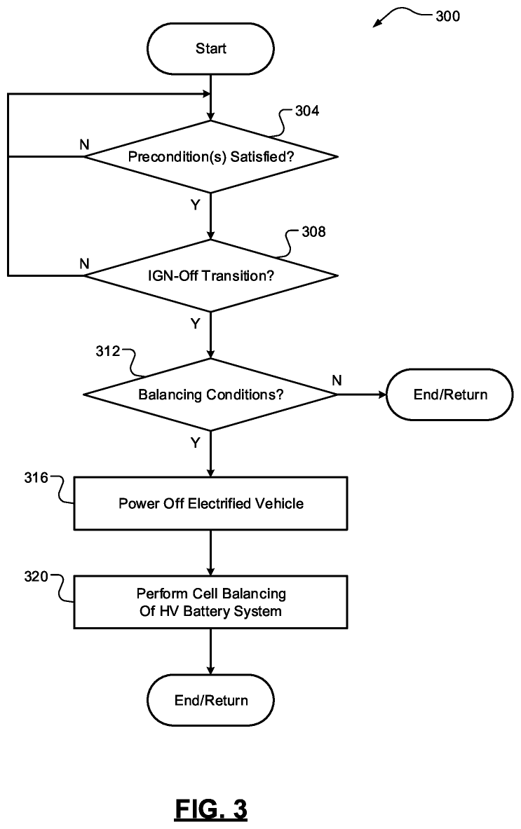

Referring now to FIG. 3, a flow diagram of an example battery management method 300 for performing cell balancing for a HV battery system of an electrified vehicle according to the principles of the present application is illustrated. While the electrified vehicle 100 and its components (HV battery system 104, BMS 108, LV battery system 128, sensor(s) 136, etc.) are specifically referenced herein for illustrative/descriptive purposes, it will be appreciated that the method 300 could be applicable to any suitable electrified vehicle having a HV battery system and a BMS. At 304, the BMS 108 determines whether an optional set of preconditions are satisfied. This could include, for example only, the electrified vehicle 100 being powered on and operational and no malfunctions or faults being present that would otherwise affect a cell balancing procedure.

When true, the method 300 proceeds to 308. Otherwise, the method 300 could end or return to 304 until these precondition(s) are satisfied. At 308, the BMS 108 detects whether the ignition-off transition is occurring whereby the electrified vehicle 100 is transitioned to the park state and subsequently thereafter powered off. In contrast to the conventional techniques, this does not require performing cell balancing during specific stable/non-dynamic operating conditions of the electrified vehicle 100 and does not require additional hardware to perform cell balancing during operation of the electrified vehicle 100.

When the ignition off-transition is not detected at 308, the method 300 ends or returns to 304 or 308. When the ignition-off transition is detected at 308, the method 300 proceeds to 312. At 312, during the ignition-off transition, the set of measured parameters are obtained by the BMS 108 from the set of sensors 136 and it is determined whether cell balancing is necessary and is appropriate (e.g., given the current SOC of the LV battery system 128). In contrast to the conventional techniques, the BMS 108 does not actively monitor, using the set of sensors 136, the measured voltages of the plurality of HV battery cells of the HV battery system during operation of the electrified vehicle 100. When cell balancing is not necessary, the electrified vehicle 100 is powered off and the method 300 ends or returns to 304 (i.e., no cell balancing occurs).

Otherwise, the method 300 proceeds to 316 where the electrified vehicle 100 is powered off and at 320, after the electrified vehicle 100 is powered off, the BMS 108 performs cell balancing of the voltages of the plurality of HV battery cells 140 of the HV battery system 104 using the set of measured parameters as previously discussed herein. After performing the cell balancing of the HV battery system 104, the HV battery system 104 is now in a better state for operation during a subsequent drive cycle of the electrified vehicle 100, which thereby could extend the life of the HV battery system 104 and decrease corresponding costs. The method 300 then ends or returns to 304 for one or more additional cycles.

It will be appreciated that the term “controller” as used herein refers to any suitable control device or set of multiple control devices that is/are configured to perform at least a portion of the techniques of the present application. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present application. The one or more processors could be either a single processor or two or more processors operating in a parallel or distributed architecture.

It should also be understood that the mixing and matching of features, elements, methodologies and/or functions between various examples may be expressly contemplated herein so that one skilled in the art would appreciate from the present teachings that features, elements and/or functions of one example may be incorporated into another example as appropriate, unless described otherwise above.

What is claimed is:

1. A battery management system (BMS) for a high voltage (HV) battery system of an electrified vehicle, the BMS comprising:
a set of sensors configured to determine a set of measured parameters including at least (i) voltages of a plurality of HV battery cells of the HV battery system and (ii) a state of charge (SOC) of a low voltage (LV) battery system of the electrified vehicle; and
a controller configured to:
detect an ignition-off transition whereby the electrified vehicle is transitioned to a park state and subsequently powered off;
during the ignition-off transition, obtain the set of measured parameters from the set of sensors; and
after the electrified vehicle is subsequently powered off, perform cell balancing of voltages of the plurality of HV battery cells of the HV battery system using the set of measured parameters,
wherein the performing of cell balancing of the voltages of the plurality of HV battery cells extends a useful life of the HV battery system.

2. The BMS of claim 1, wherein the controller is configured to perform cell balancing while the electrified vehicle is asleep and prior to the electrified vehicle being awoken and powered on.

3. The BMS of claim 1, wherein the controller is not configured to perform cell balancing during specific stable/non-dynamic operating conditions of the electrified vehicle.

4. The BMS of claim 3, wherein the BMS does not require additional hardware to perform cell balancing during operation of the electrified vehicle.

5. The BMS of claim 1, wherein the controller is configured to perform cell balancing when the measured SOC of the LV battery system satisfies a minimum SOC threshold.

6. The BMS of claim 5, wherein the minimum SOC threshold corresponds to a required amount of SOC from the LV battery system for distribution amongst the plurality of HV battery cells as part of the cell balancing.

7. The BMS of claim 1, wherein the BMS does not actively monitor, using the set of sensors, the measured voltages of the plurality of HV battery cells of the HV battery system during operation of the electrified vehicle.

8. A battery management method for performing cell balancing for a high voltage (HV) battery system of an electrified vehicle, the method comprising:
detecting, by a controller, an ignition-off transition whereby the electrified vehicle is transitioned to a park state and subsequently powered off;
during the ignition-off transition, obtaining, by the controller and from a set of sensors, a set of measured parameters including at least (i) voltages of a plurality of HV battery cells of the HV battery system and (ii) a state of charge (SOC) of a low voltage (LV) battery system of the electrified vehicle; and
after the electrified vehicle is subsequently powered off, performing, by the controller, cell balancing of voltages of the plurality of HV battery cells of the HV battery system using the set of measured parameters,
wherein the performing of cell balancing of the voltages of the plurality of HV battery cells extends a useful life of the HV battery system.

9. The method of claim 8, wherein the cell balancing is performed by the controller while the electrified vehicle is asleep and prior to the electrified vehicle being awoken and powered on.

10. The method of claim 8, wherein the controller is not configured to perform cell balancing during specific stable/non-dynamic operating conditions of the electrified vehicle.

11. The method of claim 10, wherein the electrified vehicle does not require additional hardware to perform cell balancing during operation of the electrified vehicle.

12. The method of claim 8, wherein the cell balancing is performed by the controller when the measured SOC of the LV battery system satisfies a minimum SOC threshold.

13. The method of claim 12, wherein the minimum SOC threshold corresponds to a required amount of SOC from the LV battery system for distribution amongst the plurality of HV battery cells as part of the cell balancing.

14. The method of claim 8, wherein the controller does not actively monitor, using the set of sensors, the measured voltages of the plurality of HV battery cells of the HV battery system during operation of the electrified vehicle.
